(19) United States
(12) Patent Application Publication
(10) Pub. No.: US 2024/0009732 A1
(43) Pub. Date: Jan. 11, 2024

(54) METHOD FOR PRODUCING A COMPONENT FROM A SINTERING POWDER

(71) Applicant: Miba Sinter Austria GmbH, Laakirchen (AT)

(72) Inventors: Jürgen VOGLHUBER, Eberstalzell (AT); Manuel POHN, Lenzing (AT); Richard FUCHS, Fischlham (AT); Michael BUCHEGGER, Vorchdorf (AT)

(21) Appl. No.: 18/346,711

(22) Filed: Jul. 3, 2023

(30) Foreign Application Priority Data
Jul. 5, 2022 (AT) A50489/2022

(51) Int. Cl. B22F 3/16; B22F 1/105

(52) U.S. Cl. CPC B22F 3/16; B22F 1/105; B22F 2998/10; B22F 2301/35

(57) ABSTRACT

A method for manufacturing a component from a metallic sintering powder comprises the steps of providing the sintering powder, pressing the sintering powder into a green compact in a press mold, sintering the green compact, wherein a first lubricant is added to the sintering powder, and wherein the press mold is provided with a further lubricant which has a kinematic viscosity at 20° C. of between 100 cSt and 450 cSt, at least in a partial area of the surface in which the sintering powder is in contact with the press mold.

### CROSS-REFERENCE TO RELATED APPLICATIONS

This application claims priority under 35 U.S.C. § 119(a)-(d) of Austrian Patent Application No. A50489/2022, filed Jul. 5, 2022, which is hereby incorporated by reference in its entirety.

### TECHNICAL FIELD

The field of the present disclosure relates to a method for manufacturing a component from a metallic sintering powder, comprising the steps: providing the sintering powder, pressing the sintering powder into a green compact in a press mold, sintering the green compact, wherein a first lubricant is added to the sintering powder, and wherein the press mold is provided with a further lubricant at least in a partial area of the surface in which the sintering powder is in contact with the press mold.

The present disclosure further relates to a component made of a metallic sintering powder.

### BACKGROUND

It is known to use lubricants in the production of green compacts for sintered components. For example, EP 1 440 751 B1 describes a method for producing a sintered body forming at least teeth of a sprocket comprising sintered metal particles forming a sintered structure and having a maximum particle size of 100 μm or smaller, and carbon dispersed in the sintered structure in an amount of to 1.0 wt. % based on a total mass of the sintered body, comprising the steps of preparing a metal powder mixture, said metal powder mixture comprising a fine metal powder having a particle size of 75 μm or smaller, a graphite powder in an amount of 0.1 to 1.0 wt. %, and a powder lubricant in an amount of 0.05 to 0.80 wt. % based on a total mass of the metal powder mixture, compacting the metal powder mixture to form a green compact; and sintering the green compact, wherein the metal powder mixture is compacted while being heated to a temperature of 100° C. or higher. The mold for compacting the metal powder is preheated to a temperature of 120° C. or higher. Further, lubricant may be applied to the mold prior to compaction, the lubricant being that which is also added to the powder mixture.

US 2018/036984 A1 describes a method for forming a compact based on a press forming method, comprising the steps: filling raw material powder into a cavity formed by an outer mold and a lower punch or formed by an outer mold, a lower punch and a core bar, pressing the raw material between an upper punch and the lower punch to form a compact, and pressing out the compact from the outer mold, wherein a lubricating film of a press mold lubricant containing an oil as a main component is formed on at least a part of the inner surface of the outer mold or the inner surface of the outer mold and the outer circumferential surface of the core bar, and thereafter sintering powder is filled in the cavity and pressed into the compact so that the density ratio of the compact is not less than 93%. The press mold lubricant may contain a solid lubricant.

The use of lubricants for the production of green compacts for sintering is further described in JP 57-78993 B2, JP 2007-296551 A, JP 2003-096533 A, EP 973 624 B1, U.S. Pat. No. 6,344,169 B2, JP 2001-181701 A, DE 11 2005 000 921 B4, EP 1 724 037 B1, JP 2009-120918 A, EP 1 170 075 B1, U.S. Pat. No. 6,758,662 B2, JP 34-62378 B2, EP 0 775 186 B1, JPH09-104902 A, DE 26 33 062 B2, EP 1 563 986 B1, JP 2010-094688 A, EP 0 781 180 B1, JP5542910 A.

A need remains for an improved method of providing a highly compacted component made of a metallic sintering powder.

### SUMMARY

Such need is addressed by a method for manufacturing a component from a metallic sintering powder, comprising the steps: providing the sintering powder, pressing the sintering powder into a green compact in a press mold, sintering the green compact, wherein a first lubricant is added to the sintering powder, and wherein the press mold is provided with a further lubricant at least in a partial area of the surface in which the sintering powder is in contact with the press mold, and in which it is further provided that the second lubricant has a kinematic viscosity at ° C. between 100 centistokes (cSt) and 450 cSt.

Furthermore, according to embodiments of the present disclosure, a component made of a metallic sintering powder may be manufactured to have a minimum density of at least 93.5% of the full density.

It is an advantage here that on the one hand improved compactability within the component and on the other hand improved compactability in the press mold are made possible. Surprisingly, it was found that a viscosity of the outer lubricant in the specified range has a positive effect on the compressibility of the sintering powder. A reduction in the adhesion of the sintering powder to the surface of the press mold can thus be achieved, so that a lamination of the sintering powder can be reduced or avoided. At the same time, however, the lubricant between the powder particles can be used to prevent excessive flow, especially if it is in powder form, so that the powder particles are not “pressed away”, but the interaction between the powder particles is maintained or strengthened.

According to one embodiment, it may be provided that the first lubricant is selected from a first lubricant group comprising metal soaps, amides and compound lubricants and combinations thereof. These lubricants in particular are relatively easy to mix into the sintering powder with a high uniformity of distribution, which means that higher densities and smaller density differences can already be realized in the green compact. This in turn enables the production of a component in which the density differences are further reduced.

According to another embodiment, it may be provided that the further lubricant is selected from a further lubricant group comprising mineral oils, synthetic oils and biogenic oils and combinations thereof. These lubricants can be removed from the component surface relatively easily without leaving any residue, which means that the use of external lubrication can keep the additional effort in the entire manufacturing process to a minimum.

According to a further embodiment, it may be provided that the first lubricant is added to the sintering powder in a proportion selected from a range of wt % to 0.8 wt %. Below 0.1 wt. %, the effect of the improved compactability of the sintering powder is too low, which means that a highly compacted component can only be achieved with the powder-metallurgical process route with greater effort. At more than 0.8 wt. %, the amount of lubricant in pores or spaces between the powder particles becomes so large that this may counteract further compaction.

Preferably, according to one embodiment, a lubricant free of solid lubricants and extreme pressure additives is used as a further lubricant. An unwanted change in the component properties due to the embedding of these additives in the surface of the component can thus be more easily avoided. This in turn also allows a reduction in the amount of post-processing required for the sintered component.

However, according to a further embodiment, a solid lubricant may be added to the sintering powder itself to improve the compressibility. According to a further embodiment, this solid lubricant may be selected from a solid lubricant group comprising manganese sulfide, tungsten sulfide, bismuth sulfide and combinations thereof in order to further improve this effect and/or can also be added to the sintering powder in a proportion of up to a maximum of 5 wt % in order to improve this effect according to a further embodiment.

According to one embodiment of the component, it may be provided that a neutral zone in which the density is more than 0.4% less than the minimum density, has a layer thickness of at most 10% of the component height. This means that components with a uniform density distribution over the entire component height can be provided, which means that such sintered components have an improved property profile.

### BRIEF DESCRIPTION OF THE DRAWINGS

For the purpose of better understanding of the invention, this will be elucidated in more detail by means of the figures below.

These show respectively in a very simplified schematic representation:

FIG. 1 a press mold;

FIG. 2 a component manufactured according to the method.

### DETAILED DESCRIPTION

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

Unless otherwise stated in the description, information on standards always refers to the latest version valid on the filing date of this application.

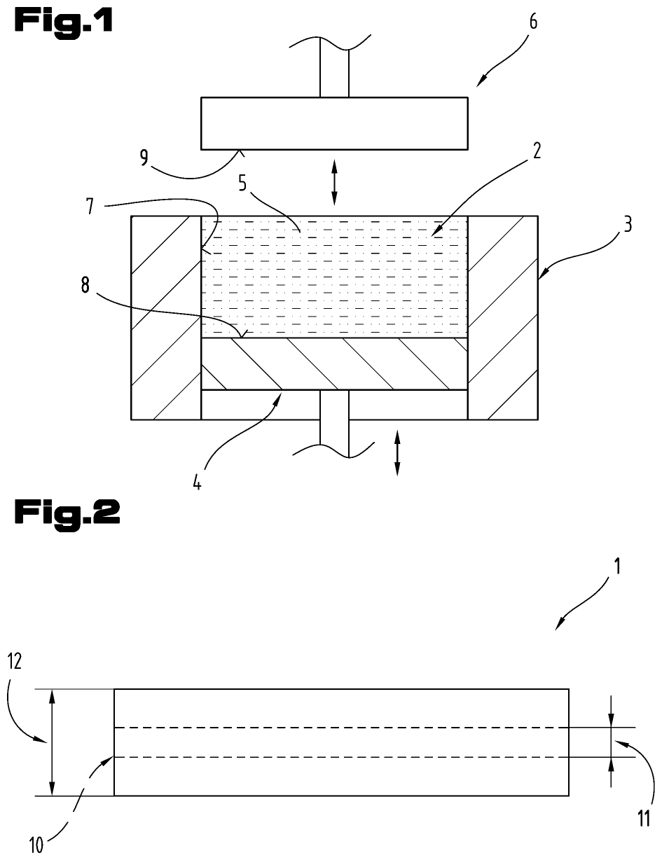

In principle, the production of a component 1 (also referred to as a sintered component), as shown in simplified form in FIG. 2, follows the known method routes. In simplified terms, a sintering powder 2 is filled into a press mold 3 (also referred to as a die), as shown in an example in FIG. 1, and pressed into a so-called green compact. The green compact, which may be subjected to green compact machining, is then sintered to form the component 1, which may be machined and/or hardened after sintering.

Preferably, an iron powder mixture is used as the sintering powder 2. This may contain a total of up to 10 wt %, in particular up to 7 wt %, of metallic non-ferrous alloy elements, such as molybdenum, nickel, copper or chromium, up to 5 wt %, in particular up to 3 wt %, of graphite, up to 3 wt %, in particular up to 1.5 wt %, of pressing aids and up to 1 wt %, in particular up to 0.5 wt %, of an (organic) binder. These powder mixtures, in particular the composition, are not to be understood as limiting for the invention, although the method is preferably used for sintered steels (difficult to compress). Thus, other sintering powders, for example based on a non-ferrous metal, etc., may also be used in the method.

For the production of an iron-based sintering powder 2, a pure iron powder or a pre- or semi-alloyed iron powder may be used as a base material. If necessary, further alloying elements as well as pressing aids can be added to this base powder, or so-called master-batches are pre-mixed in a highly concentrated form, possibly also using temperature and/or solvents, and then mixed with iron powder or mixed directly into the iron powder by adding the individual components.

Typical mixtures are, for example:
1) Fe with 0.85 wt. % Mo pre-alloyed+0.1 wt. % to 0.3 wt. % C+0.1 wt. % to 1.0 wt. % pressing aid and possibly binder,
2) Fe+1 wt. % to 3 wt. % Cu+0.5 wt. % to 0.9 wt. % C+0.1 wt. % to 0.8 wt. % pressing aid and possibly binder,
3) Fe with 0.8 wt. %-3.0 wt. % Cr, 0 wt. %-0.5 wt. % Mo, 0 wt. %-2.5 wt. % Ni, wt. % 0-2.5 wt. % Cu, 0.2 wt. %-1 wt. % pressing aid and possibly binder.

The iron powder mixture or generally the sintering powder is filled into the press mold 3 and compacted and shaped in it using a coaxial pressing method. For this purpose, the press mold 3 with a lower punch 4 forms a mold cavity 5 for receiving the sintering powder 2. After filling the sintering powder 2 into the mold cavity 5, the latter is closed with an upper punch 6 and the sintering powder 2 is compacted into the green compact by the movement of the upper punch 6 towards the lower punch 4 and, if necessary, the (simultaneous) movement of the lower punch 4 towards the upper punch 6.

Depending on the bulk density and theoretical density of the powder mixtures, for example, pressures of 600 MPa to 1200 MPa are applied.

The green compacts obtained in this way are sintered into component 1 by single- or multi-stage sintering. The temperature during sintering may be between 1100° C. and 1350° C., depending on the alloy system used, and the sintering time can be between 10 minutes and 120 minutes. After sintering, the component 1 may additionally be calibrated in a calibration die.

The component 1 may optionally also be subjected to a heat treatment (e.g., case hardening or low-pressure carburization with subsequent gas or oil quenching), if necessary after thermal degreasing. If sinter-hardening materials are used, either a further sintering process with subsequent hardening from the sintering heat may be carried out or non-carburizing processes such as induction hardening.

The mechanical finishing of the sintered component 1 or the mechanical processing of the green compact may be carried out, for example, by grinding, honing, lapping, fine drilling, etc.

It is provided that a first lubricant is added to the sintering powder 2. It should be noted that, for the purposes of this description, the first lubricant does not fall under the aforementioned term “pressing aid”.

The first lubricant is added to the sintering powder or mixed in during powder mixing so that it is as homogeneously distributed as possible in the powder mixture. According to one embodiment, the proportion of the first lubricant in the total composition of the sintering powder 2 may be between 0.1 wt % and 0.8 wt %, in particular between 0.2 wt % and 0.6 wt %.

The first lubricant may preferably be selected from a first lubricant group comprising metal soaps, amides and compound lubricants and combinations thereof. Preferably, a powdered first lubricant is used. However, other suitable lubricants may also be used as first lubricants, for example also non-solid lubricants such as liquid lubricants.

It is further provided that the press mold 3 is provided with a further lubricant at least in a partial area of the surface in which the sintering powder is in contact with the press mold 3.

The further lubricant is preferably a synthetically produced oil with a kinematic viscosity at 20° C. between 100 cSt and 450 cSt, in particular between 300 cSt and 425 cSt, preferably between 350 cSt and 400 cSt. The further lubricant may be selected from a further lubricant group comprising mineral oils, synthetic oils and biogenic oils and combinations thereof. However, other suitable lubricants may also be used as a further lubricant. Preferably, the further lubricant is always a liquid substance (especially an oil) in the application. Particularly preferred is a liquid, synthetically produced further lubricant, especially one with a compressibility modulus between 1,4×10 4 bar and 3×10 4 bar.

In particular, the further lubricant is applied to an inner surface 7 of the press mold 3 and, if applicable, to a surface 8 of the lower punch 4 contacting the sintering powder 2 and/or, if applicable, to a surface 9 of the upper punch 6 contacting the sintering powder 2. Should a core bar and/or additional lower or/and upper punches be used, the outer surface(s) of the core bar and/or additional lower or/and upper punches may also be provided with the further lubricant.

The further lubricant may be sprayed, painted, etc. on the respective surface 7-9. All methods for applying liquid or solids, depending on whether the further lubricant is liquid or solid at 20° C., are applicable.

Thus, in the process, both an internal and an external lubricant are applied for compacting the sintering powder 2. It is preferred that the first lubricant is used in powder form. If the first lubricant is also used in liquid form, it preferably has a kinematic viscosity at 20° C. which is at least 10%, in particular at least 20%, preferably at least 40%, higher than the kinematic viscosity of the further lubricant at 20° C.

For example, the following combinations of first and second lubricant may be used. The first-mentioned lubricant is the first lubricant, the second-mentioned lubricant is the second lubricant.
hybrid wax (Kenolube® P11)+synthetically produced oil
amide wax+mineral oil based oil
metal stearate+mineral oil-based oil with added solid lubricants
Superlube®+biogenic oil

In the preferred embodiment, the further lubricant does not contain any solid lubricants or extreme pressure additives. Extreme pressure additives (EP additives) are usually added to lubricants to prevent the welding of two metallic materials rubbing against each other, especially when (extremely) high pressures or loads occur between the materials rubbing against each other. However, the further lubricant may have additives, such as foam suppressants, anti-wear additives, antioxidants or corrosion inhibitors, in particular of a maximum of 5 wt. % in total.

Preferably, the further lubricant is a purely synthetically produced lubricant without mineral oil content.

According to a further embodiment, it may be provided that at least one solid lubricant may be added to the sintering powder 2. In particular, this solid lubricant is not formed by graphite if the component 1 is made of a sintering steel powder, or is generally made of a powder that already contains graphite as an alloying component, such as for the formation of carbides. The solid lubricant is generally also not identical with the first lubricant.

The solid lubricant may be selected from a solid lubricant group comprising manganese sulfide, tungsten sulfide, bismuth sulfide (Bi₂S₃) and combinations thereof.

The solid lubricant may be added to the sintering powder 2 in a proportion of up to a maximum of 5 wt %, in particular in a proportion of between 0.1 wt % and 4 wt %.

It should be noted at this point for the sake of completeness that all components of the sintering powder 2, i.e., including the first lubricant and, if applicable, solid lubricant, add up to 100 wt %.

With the application of the first and the further lubricants according to the above explanations, it is possible to press a green compact which has a minimum density of 92%, in particular a minimum density of 92.5% to 94%, of the full density of the corresponding material.

The term “full density” refers to the density of the material without pores and gaps as they occur in powder-metallurgical components, i.e., for example the density of the corresponding casting material.

This green compact may subsequently be used to produce a component 1 that has a minimum density of at least 93.5%, in particular a minimum density of 94% to 95% of the full density. The edge zone of the component 1 starting at its surface may also have a density of up to 99.8% of the full density.

The method enables further that a neutral zone 10 of the component 1, in which the density is more than 0.4% less than the minimum density, has a layer thickness 11 of at most 10% of the component height 12.

Density differences occur when green compacts are pressed. The area where these occur is called the “neutral zone”. These density differences increase with increasing component height. By producing the green compact and thus the component 1 with methods according to the present disclosure, the pressing density can be increased, whereby the effect of the density differences can be reduced.

However, component 1 may also have only one density division or density distribution. For example, with a minimum density of 7.38 g/cm³, the component 1 can thus have a minimum density of 7.35 g/cm³ when compaction is carried out to 94% of the full density. With a minimum density of 7.40 g/cm³, the minimum density (94%) is therefore 7.37 in component 1.

In particular, the method can achieve press densities of at least 7.25 g/cm³ with iron-based sintering powders 2.

The following tests were carried out to evaluate the method. In each case, a component 1 was produced from a sintering steel powder of the composition Fe with 0.85 wt % Mo pre-alloyed+0.2 wt % C+0.2 wt % Intralube®. The component height 12 of component 1 after sintering was 35 mm in each case. Pressure and temperature were chosen according to the values mentioned above.

### Example 1

0.2 wt. % hybrid wax+0.25 wt. % MnS were added to the sintering powder. A synthetic forming oil (KADE VP403) was applied to the surface of the press mold 3 (die).

The component 1 produced in this way had an overall density of 7.42 g/cm³. The following density values were measured:
Top: 7.45 g/cm³ (0 mm-7 mm from the top)
Top center: 7.43 g/cm³ (7 mm-14 mm from the top)
Centre: 7.42 g/cm³ (14 mm-21 mm from the top)
Bottom center: 7.42 g/cm³ (21 mm-28 mm from the top)
Bottom: 7.42 g/cm³ (28 mm-35 mm from the top)

### Example 2

0.3 wt. % hybrid wax+0.50 wt. % WS₅ were added to the sintering powder. A synthetic forming oil was applied to the surface of the press mold 3 (die).

The component 1 produced in this way had an overall density of 7.44 g/cm³. The following density values were measured:
Top: 7.46 g/cm³ (0 mm-7 mm from the top)
Top center: 7.44 g/cm³ (7 mm-14 mm from the top)
Centre: 7.44 g/cm³ (14 mm-21 mm from the top)
Bottom center: 7.44 g/cm³ (21 mm-28 mm from the top)
Bottom: 7.43 g/cm³ (28 mm-35 mm from the top)

The embodiments show or describe possible implementation variants, wherein various combinations of the individual implementation variants are also possible.

Finally, for the sake of order, it should be noted that for a better understanding of the structure of the press mold 3 or the component 1, these are not necessarily shown to scale.

It will be obvious to those having skill in the art that many changes may be made to the details of the above-described embodiments without departing from the underlying principles of the invention. The scope of the present invention should, therefore, be determined only by the following claims.

The invention claimed is:

1. A method for manufacturing a component from a metallic sintering powder, comprising the steps:
providing the sintering powder,
pressing the sintering powder into a green compact in a press mold,
sintering the green compact,
wherein a first lubricant is added to the sintering powder,
and wherein the press mold is provided with a further lubricant at least in a partial area of the surface in which the sintering powder is in contact with the press mold,
wherein the second lubricant has a kinematic viscosity at 20° C. of between 100 cSt and 450 cSt.

2. The method according to claim 1, wherein the first lubricant is selected from the group consisting of metal soaps, amides and compound lubricants and combinations thereof.

3. The method according to claim 1, wherein the further lubricant is selected from the group consisting of mineral oils, synthetic oils and biogenic oils and combinations thereof.

4. The method according to claim 1, wherein the first lubricant is added to the sintering powder in a proportion selected from a range of 0.1 wt % to 0.8 wt %.

5. The method according to claim 1, wherein a lubricant which is free from solid lubricants and extreme pressure additives is used as the further lubricant.

6. The method according to claim 1, wherein a solid lubricant is added to the sintering powder.

7. The method according to claim 6, wherein the solid lubricant is selected from the group consisting of manganese sulfide, tungsten sulfide, bismuth sulfide, and combinations thereof.

8. The method according to claim 6, wherein the solid lubricant is added to the sintering powder in a proportion of up to a maximum of 5 wt %.

9. A component made of a metallic sintering powder produced by a method according to claim 1, wherein the component has a minimum density of at least 93.5% of the full density.

10. The component according to claim 9, wherein a neutral zone, in which the density is more than 0.4% less than the minimum density, has a layer thickness of at most 10% of the height of the component.
